(19) United States
(12) Patent Application Publication
(10) Pub. No.: US 2006/0261719 A1
(43) Pub. Date: Nov. 23, 2006

(54) Field emitter device

(76) Inventor: Neil Fox, Winchombe, Gloucestershire (GB)

Correspondence Address: MARGER JOHNSON & MCCOLLOM, P.C., 210 SW MORRISON STREET, SUITE 400, PORTLAND, OR, 97204, US

(21) Appl. No.: 10/569,359

(22) PCT Filed: Aug. 27, 2004
(86) PCT No.: PCT/GB04/03696

§ 371 Date: Feb. 24, 2006

(30) Foreign Application Priority Data
Aug. 29, 2003 (GB) 0320222.3

(51) Int. Cl. H01J 1/00; H01J 9/02; H01J 1/02

(52) U.S. Cl. 313/311; 313/310; 313/309

(57) ABSTRACT

An electron emitter including a high work function metal 18 encapsulating a metal-doped, nanocrystalline diamond particle layer 14 in contact with a planar surface of a low workfunction metal cathode 12, and a method of fabrication of the same is disclosed.

The method may include formulating the conductive nanodiamond powder with a metallic solution, containing the high workfunction metal, and disposing it on the metal cathode 12 to form a composite material layer containing surface areas exhibiting low electron affinity. The resulting cold cathode structure has a low extraction field needed for efficient emission, a means to limit the emission current per unit area, and a reduced emission sensitivity to surface adsorption/desorption effects.

### TECHNICAL FIELD OF THE INVENTION

The invention relates to field-controlled electron emitters, and more particularly to electron emission devices that employ conductive nanodiamond emission areas and a method of making the same.

### DESCRIPTION OF RELATED ART

Cold cathode electron emitters continue to find new applications as sources of electrons in a wide range of vacuum devices including: flat panel displays, klystrons and travelling wave tubes, lamps, ion guns, miniature X-ray tubes, e-beam lithography, high energy accelerators, free electron lasers and electron microscopes and microprobes. An improved cold electron emitter and any process which reduces the complexity of fabricating the emitters is clearly useful.

A number of desirable characteristics are known to be advantageous for the cathode materials of a cold electron source. The uniformity of emission current extracted from a given emission area due to the application of an external electric field must be high (better than ±10% locally) and stable against fluctuations over a very long period of time, typically tens of thousands of hours. The operating voltages must be low so that CMOS driver circuitry can be used. The cathode must be resistant to chemical poisoning, back bombardment, temperature extremes and arcing damage. The method of manufacturing the cathode should be inexpensive and adaptable to being incorporated into a wide range of device applications.

Several types of electron emission are known. Thermionic emission involves an electrically charged particle emitted by an incandescent substance. Photoemission releases electrons from a material by means of energy supplied by the incidence of radiation. Secondary emission occurs by bombardment of a substance with charged particles such as electrons or ions. Electron injection involves the emission from one solid to another. Field emission refers to the emission of electrons due to the application of a high electric field.

In field emission, electrons under the influence of a strong field are liberated out of a substance (usually a metal or semiconductor) into a dielectric (usually a vacuum). The electrons “tunnel” through a potential barrier instead of escaping “over” it as in thermionic or photoemission. Field emission is therefore a quantum mechanical process with no classical analog.

The shape of a field emitter affects its emission characteristics. Field emission is most easily obtained from sharply pointed needles or tips whose ends have been smoothed into a nearly hemispherical shape by heating. Tip radii as small as 100 Å have been reported. As an electric field is applied, the electric lines of force diverge radially from the tip and the emitted electron trajectories initially follows these lines of force. Fabrication of such fine tips normally requires extensive fabrication facilities to finely tailor the emitter into a conical shape. Furthermore, it is difficult, tedious and expensive to build high densities of field emitters with such fine featured lithography on large area substrates. Therefore there is a need for a method of making high densities of electron emitters without the need for fine featured lithography. Previous electron emitters were typically made of metal (such as Mo) or semiconductor material (such as Si) in nanometer sizes. While useful emission characteristics have been demonstrated for these materials, the control voltage required for emission is relatively high (around 100V) because of the materials' high work functions. The high voltage operation increases damage caused by ion bombardment and surface diffusion on the emitter tips. High voltage operation also necessitates high power densities to be delivered from an external source to produce the desired current density. The vulnerability of these materials to ion bombardment, chemically active species and temperature extremes is also a serious concern.

For a metal emitter, the workfunction of the electron emitting surface also affects its emission characteristics. The workfunction is defined as the difference in energy between the Fermi level and the vacuum level. A small workfunction requires a lower extraction field to remove electrons from a surface. For example a lithium-coated metal emitter with a surface workfunction of 2.6 eV will have a lower vacuum emission potential barrier than a similar metal emitter coated with platinum, which exhibits a surface workfunction of 5.3 eV. In a wide band gap semiconducting material such as synthetic diamond, the Fermi level lies between the conduction band minimum and the valence band maximum. In such a material the workfunction changes as the Fermi level changes due to impurity doping or lattice defects. Also, the energy difference between the conduction band minimum and the vacuum level is a fundamental material property referred to as electron affinity. Therefore the workfunction (φ) and electron affinity (χ) are the same in a metal, but have different values in a wide band gap material such as undoped diamond where φ˜4.5 eV, and χ˜1 eV. Diamond is a useful material for cold cathode emitters because of its robust mechanical and chemical properties. The majority of the disclosures pertaining to field emission devices employing diamond, use Chemical Vapour Deposition (CVD) techniques to form and/or incorporate diamond or diamond-like thin films onto substrates containing cathode structures.

In order to take advantage of diamond's low electron affinity property, and to achieve low voltage emission, a conventionally doped, n-type material is required. However, the n-type doping process has not been reliably achieved for thin film synthetic material. This has led to alternative methods being disclosed that attempt to produce low voltage operation from diamond by growing or treating it so that the material contains an abnormally high quantity of defects. Such approaches usually require the material to be hydrogenated, to improve its conductivity and to allow it to exhibit a low electron affinity surface such that the emission barrier is advantageously lowered. Although this method can give rise to improved diamond emitters, the emission current is not uniformly distributed across the emission area but rather originates from clusters of sites, within each of which the emission current fluctuates in a manner that is not under the control of the applied electric field. In addition, these diamond emitters have been found to be highly susceptible to damage due to arcing events.

When considering the possible mechanisms by which low field emission could operate in synthetic, semiconducting diamond thin films, it is evident that intentional and/or unintentional impurity sub-bands can be present in the optical band gap of diamond. Sub-bands can have a prominent role to play in supplying electrons to a diamond emission barrier or material interface if they are positioned close to the conduction band minimum. Lithium is reported to form sub-bands as low as 0.1 eV (theory) up to 1 eV below the conduction band minimum, if the doping levels are high (>1×10¹⁹ cm⁻³ ). However, the bulk conductivity of in-situ doped CVD material containing lithium is low, causing a significant potential to be dropped across the film, when a metal back contact has a voltage applied to it. Consequently, the extraction field for emission current will remain high (>>10V/micron) because of the small number of carriers available for conduction. If the sub-bands are more than 1 eV below the conduction band minimum, the efficiency of the injecting back contact will be low. The field emission characteristics of n-type, CVD diamond thin films diamond reported in the literature tend to exhibit carrier transport dominated by hot electron injection from the back contact. Only nanocrystalline thin films, which are made to exhibit good quality electrical contacts, are likely to exhibit ballistic carrier transport.

A further aspect of efficient back contact electron injection into ultra-thin (<10 nm), n-type, nanocrystalline, semiconductor emitters, is the generation of high values of space charge causing downward band bending within the semiconductor. Downward band bending can also be obtained by the application of an ultra-thin layer of metal to the surface of a wide band gap semiconductor, such as diamond. This effect has been reported for CVD diamond coated with non-carbide-forming metals. The lowering of the vacuum emission barrier that can accompany large band bending inside an ultra-thin, n-type semiconductor, leads to a reduction in the electron affinity of the emission surface, which is beneficial for efficient cold cathode operation. There exists a need for simpler methods of making cold cathode emission areas with improved electron emitter structures and pixellated arrays using nanodiamond.

### SUMMARY OF THE INVENTION

According to a first aspect of the present invention, there is provided a field emission device comprising a layer of lithiated nanodiamond particles on a substrate.

According to a second aspect of the present invention, there is provided a method of manufacturing a field-emission device including lithiated nanodiamond particles.

In a further aspect of the present invention, there is provided a pixellated emitter array comprising at least one field-emission device of the first aspect of the present invention.

The present invention advantageously uses commercially available diamond powders for making the improved cold cathode electron sources (and the resulting emitter structures). The diamond powders are treated to enhance their conductivity, electron affinity and their capability for electron emission upon application of electric fields of 0.5-5V/micron. Specifically, electron emitters containing nanodiamond particles with an average particle size of 25 nm, are heat-treated in an inert atmosphere, subsequently under high vacuum, and with lithium or a lithium compound to produce metal-doped nanodiamond with a controllable hydrogen content. This material is disposed onto a low workfunction, metal alloy cathode contact. Following an air-bake cycle, an emitter structure is formed. The lithium-doped, nanodiamond particles adhere as a mono-layer to the metal cathode contact. In some embodiments of the present invention the nanodiamond particles are themselves conformally coated with the high workfunction metal to a thickness in the range of 15 nm down to 1 nm. The resulting emitter structure has a low extraction field needed for efficient, uniform emission, a means to limit the emission current per unit area, and a reduced emission sensitivity to surface absorption/desorption effects.

The method of fabrication of the present invention advantageously involves only a small number of process steps. Furthermore, advantage is found as the formation of the nanodiamond emitter structure does not require the use of ultra-fine lithography, thin film CVD or necessitate the use of dry or wet etch processes.

### BRIEF DESCRIPTION OF THE DRAWINGS

For a better understanding of the present invention, and to show how it may be put into effect, reference will now be made, by way of example, to the accompanying drawings in which:

FIG. 1A-1C show cross-sectional views of successive stages of fabricating a cold cathode emitter in accordance with a first embodiment of the present invention.

FIG. 2A-2D show cross-sectional views of successive stages of fabricating a cold cathode emitter in accordance with a second embodiment of the present invention.

FIG. 3A-3G show cross-sectional views of successive stages of fabricating a cold cathode emitter in accordance with a third embodiment of the present invention.

FIG. 4A and 4B show samples of finished emitter cathode devices.

FIG. 5 shows a cross-sectional view of a vertically-gated, cold cathode emitter element of the present invention.

FIG. 6 shows a cross-sectional and a plan view of an example matrix-addressable emitter array pixel element incorporating the emitter structure of the present invention.

FIG. 7 shows a cross-sectional and a plan view of a further example matrix-addressable emitter array pixel element incorporating the emitter structure of the present invention.

### DETAILED DESCRIPTION OF EMBODIMENTS

A significant aspect of the invention is the use of nanodiamond particles that have been processed to be conductive, with lithium as the dominant metal impurity.

The term nanodiamond particles refers to diamond particles in which the domain size is in the range from 2 nm-50 nm.

The nanodiamond material used as the starting material for the process can be readily obtained from commercial sources, and may be composed of single crystal or polycrystalline particles. This starting material is first graded prior to use to obtain a powder with an average particle size of 25 microns or less. The material is next thermally cycled to stabilise it at a temperature in the range of 950-1150° C. in an ambient of hydrogen/deuterium, helium or inert gas or in an ultra-high vacuum. In a subsequent process cycle, lithium is introduced as a vapour and made to react with the nanodiamond particles at temperature. Alternatively, a lithium compound such as lithium fluoride or lithium carbonate, or preferably lithium hydride is either applied as a conformal coating to each particle beforehand, or introduced into the reaction vessel containing the nanodiamond. Specifically, lithium hydride placed in a crucible with the nanodiamond particles in an atmosphere of argon is heated to around 680° C. The chamber is then evacuated and the mixture heats up to around 850-900° C., as there is no longer any convection of heat array from the mixture. The mixture is then pulse heated to a temperature of 950° C.-1150° C., for example around 1100° C., in order to control the process and protect the diamond structure. This particular technique increases the amount of lithium decorating and diffused into each nanoparticle. After the lithium or lithium compound has been allowed to decorate and also diffuse into the diamond nanoparticles, the vessel is purged with either helium, neon or argon gases and subjected to a further anneal at temperature. Afterwards the material is thermally quenched in an inert gas of ambient argon.

The result is the formation of lithium-doped nanodiamond particles, that is, nanodiamond particles, in which lithium has diffused into at least a part of at least a surface layer of the nanodiamond particles, or in which lithium is present on at least a part of a surface of the nanodiamond particles.

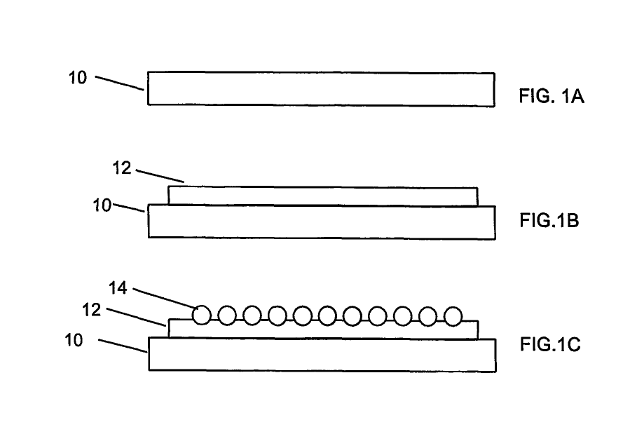

FIGS. 1A-1C are schematic diagrams showing three successive stages of fabricating a cold cathode emitter in accordance with a first embodiment of the present invention. In FIG. 1A, a substrate 10 provides a base upon which emission areas can be fabricated and this substrate 10 is a relatively flat area composed of glass or quartz. Next, as shown in FIG. 1B, a continuous cathode metal layer 12 is deposited upon the substrate. This relatively thin film comprises a metal alloy of approximately 80-120 nm depth (and that is matched to glass). The cathode metal layer 12 can be one of a group of conductive metal oxides such as indium tin oxide (ITO), zinc oxide (ZnO), aluminium-doped zinc oxide (ZnO:Al), indium-doped zinc oxide (ZnO:In), gallium- and aluminium-codoped zinc oxide (ZnO:Ga,Al) or one of a group of metal alloys such as aluminium-doped lithium (Li:Al), silver-doped lithium (Li:Ag), nichrome (Ni—Cr) or one of a group of metals such as silver (Ag), gold (Au), platinum (Pt) and nickel (Ni). A mono-layer of the lithium-doped nanodiamond particles 14 is disposed on the cathode metal contact 12 as illustrated in FIG. 1C. The device is then thermally treated in air, inert gases or a vacuum to allow the nanoparticles to become mechanically and electrically connected with the cathode metal contact 12. This contact is consolidated by subsequent vacuum processing to package the cold cathode emitter into a device. Due to the manner in which the lithium is accommodated on the surfaces and within the bulk of the nanodiamond particles 14, the conductivity is markedly improved. Therefore, the electrical interface formed between a cathode metal contact 12 and each nanodiamond particle 14 will be enhanced compared with undoped nanodiamond materials.

Where subsequent figures depict like or similar elements, these are designated by the same reference numeral. It should be noted that features shown are not shown to scale.

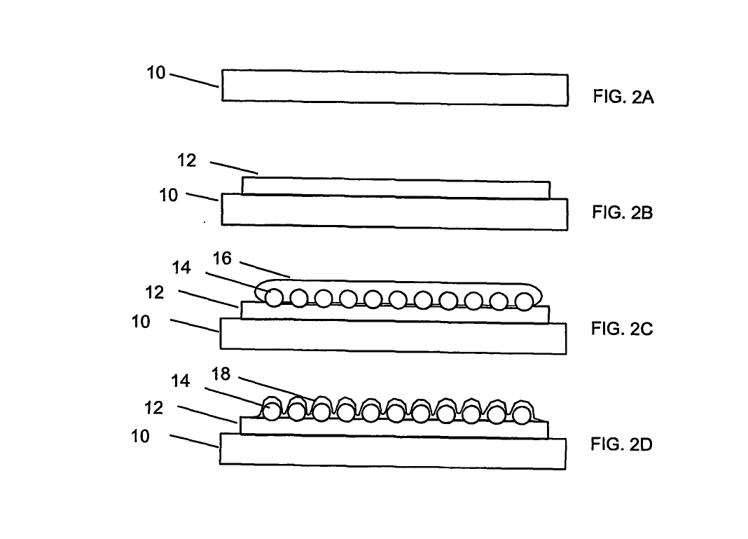

FIGS. 2A-2D are schematic diagrams showing four successive stages of fabricating a cold cathode emitter in accordance with a second embodiment of the present invention. FIG. 2A is similar to FIG. 1A.

In FIG. 2B, the metal alloy cathode 12 used as the injecting back contact, contains a lithium component and/or an indium component and forms a low resistivity layer when disposed on a supporting substrate 10 and the resistivity value of the cathode 12 does not alter significantly with subsequent substrate processing at elevated temperatures in air. The cathode 12 is deposited on the chemically pre-cleaned substrate surface 10. Evaporation is the preferred deposition technique because it enables large area films to be deposited most easily, with high uniformity, and low levels of included gas. Alternatively, plasma-assisted deposition methods could be used but extra attention needs to be taken to ensure that the deposited metal does not contain large amounts of trapped gas such as argon which is known to disrupt the operation of fabricated emitter structures and lead ultimately to their destruction. The cathode metal contact 12 is preferably deposited at an elevated temperature and the components of the alloy layer are preferably co-evaporated. Alternatively, a sequence of material evaporations is performed to construct the metal alloy layer. The metal alloy generally contains nickel(Ni), chromium(Cr), indium(In) and lithium(Li) components, and the layer thickness is typically in the range of 80-120 nm. The preferred metal alloy is nichrome(Ni—Cr(80-20)), and exhibits a resistivity one third to one fifth of the value of a pure aluminium layer.

In this second embodiment, the metal-doped nanodiamond 14 is formulated into a colloidal suspension with a solution 16 containing a metallic compound, such as silver(Ag), indium(In), nickel(Ni). Referring to FIG. 2C, the formulated suspension is disposed onto the surface of the cathode 12 preferably by a liquid dispensing method, such as an industrial inkjet printer or alternatively by a spraying, screening, or plating process. Encapsulating the lithiated nanodiamond 14 in such a metal layer 16 improves the uniformity of the emission current drawn from a given emission area, and makes operation less sensitive to surface contamination than the emitter cathodes of the prior art.

The supporting substrate 10 for the cathode 12 and nanodiamond 14, is then subjected to an air bake to allow the metallic compound 16 to decompose and allow the organic material to evaporate and the metal 18 to ‘wet’ the nanodiamond particles 14. At the completion of the air bake process, as illustrated in FIG. 2C, the lithiated nanodiamond particles 14 adhere as a monolayer to the cathode contact 12, and the nanodiamond particles 14 are conformally coated with an ultra-thin high workfunction metal layer 18, typically 1-15 nm thick. The nanodiamond particles 14 are randomly disposed, but closely packed exhibiting a particle density of greater than 1×10⁶ cm⁻². The high work function metal layer 18 is indium or indium alloy.

An advantage of formulating the nanodiamond particles 14 in a dispensable suspension is that it may be disposed onto a prepared metal cathode 12 or gated cathode structure 12 and processed last. In this way the emitter cathode structure is less likely to come into contact with chemical agents or materials associated with fabrication steps required to fashion a multi-element cold cathode device, such as an addressable pixel array.

It should also be noted that solution 16 can alternatively comprise a coating without metallic particulates, such as a screening ink.

In a further alternative, the lithium-doped nanodiamond can be suspended in a silver-lithium alloy, which can then be plated onto the cathode 12 in a form of Brashear process. This avoids the need for the heating step to remove the organic compounds.

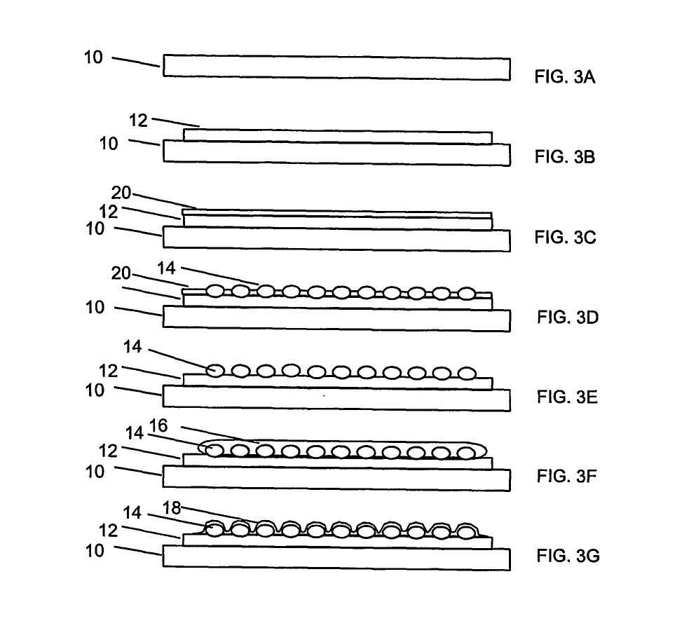

FIGS. 3A-3G are schematic diagrams showing seven successive stages of fabricating a cold cathode emitter in accordance with a third embodiment of the present invention. FIGS. 3A and 3B are similar to FIGS. 1A and 1B.

In FIG. 3C a lacquer 20 containing a material such as poly-vinyl acrylic is applied to the cathode 12 as a thin layer by spinning or spraying or printing. In FIG. 3D the lithiated nanodiamond 14 is applied to the tacky lacquer layer 20, preferably by a dusting method or alternatively by a contact transfer or air spray method. The laquer 20 is then air baked to remove the polymer to leave behind a monolayer of nanodiamond particles 14 on the cathode surface 12 (shown in FIG. 3E). In FIG. 3F an organo-metallic solution 16 (as previously described) is dispensed onto the nanodiamond layer 14 and upon subsequent air baking forms the structure of FIG. 3G.

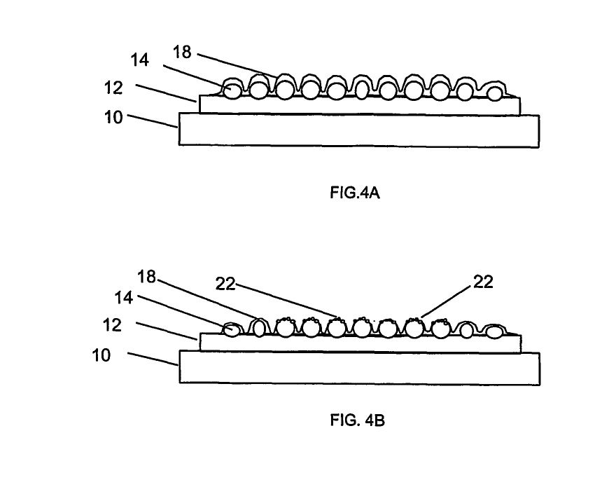

The emitter structure of FIG. 4A illustrates a monolayer of nanodiamond particles 14 that may appear to be all the same size. In practice there will be some variation in the shape and size of the nanodiamond particles 14 and this will be reflected in the variable range of thicknesses of the conformal coating of platinum or similarly chosen metal 18. FIG. 4B illustrates an extreme example of this effect. If the nature of the formulation of the organo-metallic solution 16 is altered in combination with the firing conditions for the air bake, it can be arranged that the metal 18 no longer forms a conformal coating over all of the diamond particles, but becomes discontinuous or particulate metal 22 on the nanodiamond particles surfaces.

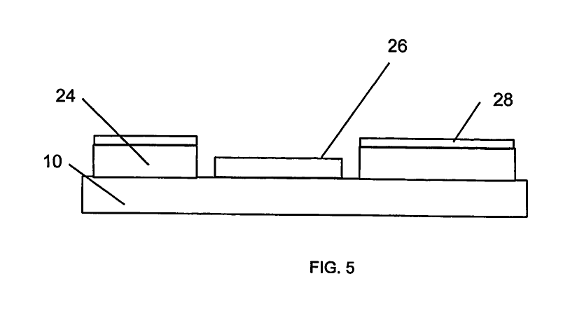

FIG. 5 schematically illustrates a cross-sectional view of a vertically-gated, cold cathode emitter element. This is an example of an addressable emitter pixel that exploits the emitter cathode fabrication method of the present invention. Insulator layer 24 and a gate 28 are located on substrate 10 with cathode emitter lines 26 positioned approximately centrally.

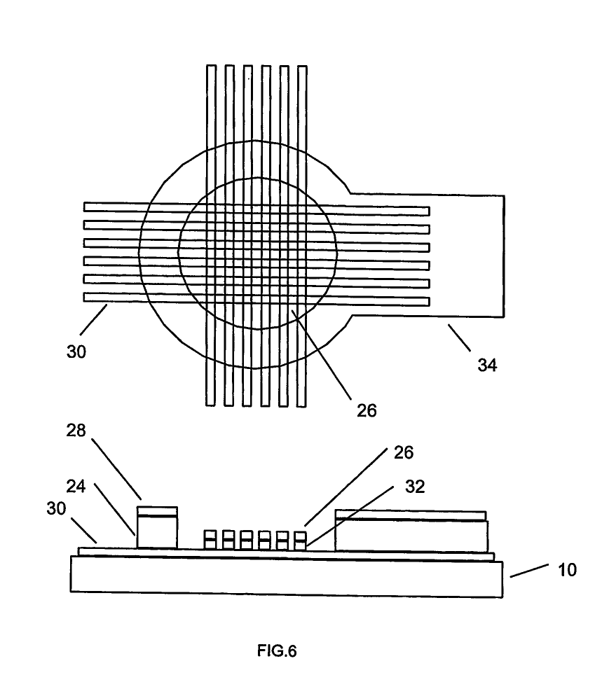

FIG. 6 shows an example of a sub-pixel, addressable emitter array element. An addressable under-gate structure 30 extracts emission from a plurality of cathode emitter lines 26 containing the processed, lithiated, nanodiamond-platinum layer and aluminium-lithium cathode layer. A circular aperture over-gate electrode 34 provides a means to control the pixel emission and e-beam spot geometry. The emitter array element 30 and upper gate 28 are electrically isolated from each other and the under-gate structure 30 by insulator layers 24 and 32.

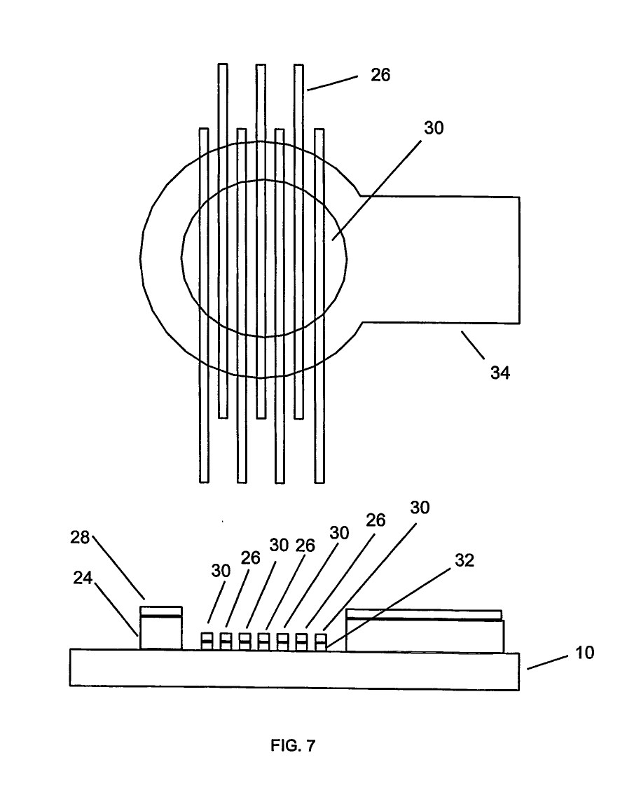

FIG. 7 illustrates an example of a sub-pixel matrix-addressable emitter cathode that uses a set of lateral gates 30 to extract electron emission from the cold cathode emitter lines 26. A second gate 28 is disposed above this in a similar manner to FIG. 5.

It can therefore be seen that the present invention provides a device and method of fabrication for providing an improved field-emission device.

The skilled person will also be aware that modifications and adjustments to the above described devices and fabrication methods can be made whilst remaining within the scope of the present invention. For example, substrate 10 may alternatively be composed of metal, ceramic or semiconductor. Further, the arrangement of the emitter cathode of FIG. 7 allows the insulating layer 32 to be omitted if desired to further simplify the fabrication of the addressable pixel.

1. A field-emission device comprising a cathode on a substrate and lithium-doped nanodiamond particles in electrical contact with the cathode.

2. The field-emission device of claim 1, wherein the lithium-doped nanodiamond particles are positioned on the cathode as a monolayer.

3. The field-emission device of claim 1, wherein the cathode is a metal alloy.

4. The field-emission device of claim 3, wherein the cathode is an alloy containing nickel, chromium, indium and lithium components.

5. The field-emission device of claim 1, wherein the layer of lithium-doped nanodiamond particles is coated with a metal having a higher workfunction than the lithium-doped nanodiamond particles.

6. A method of manufacturing a field-emission device including a cathode on a substrate, the method comprising;
doping nanodiamond particles with lithium, and depositing the lithium-doped nanodiamond particles onto the cathode.

7. The method of claim 6, wherein the step of depositing the lithium-doped nanodiamond particles onto the cathode comprises depositing a monolayer of lithium-doped nanodiamond particles.

8. The method of claim 6, wherein the cathode is an alloy containing nickel, chromium, indium and lithium components.

9. The method of claim 6, wherein the step of depositing the lithiated nanodiamond particles comprises forming a nanodiamond suspension and depositing the suspension onto the cathode.

10. The method of claim 8, wherein the method further comprises thermally treating the field-emission device to adhere the nanodiamond particles to the cathode.

11. The method of claim 6, wherein the method further comprises depositing a layer of a lacquer onto the cathode and adhering nanodiamond particles to the lacquer.

12. The method of claim 11, wherein the method further comprises thermally treating the field-emission device to adhere the nanodiamond particles to the cathode and remove the lacquer layer.

13. The method of claim 6, wherein the step of doping the nanodiamond particles with lithium comprises heating the nanodiamond particles with a lithium compound in a substantially inert atmosphere.

14. The method of claim 13, wherein the lithium compound is lithium hydride.

15. The method of claim 13, wherein the nanodiamond particles are heated with the lithium compound to around 680° C., and the method further comprises evacuating the atmosphere and then further increasing the temperature of the mixture by pulse heating.

16. A pixellated emitter array comprising at least one of the field-emission devices selected from the group consisting of the following: a cathode on a substrate and lithium-doped nanodiamond particles in electrical contact with the cathode; a cathode on a substrate and lithium-doped nanodiamond particles in electrical contact with the cathode wherein the lithium-doped nanodiamond particles are positioned on the cathode as a monolayer; a cathode on a substrate and lithium-doped nanodiamond particles in electrical contact with the cathode wherein the cathode is a metal alloy; a cathode on a substrate and lithium-doped nanodiamond particles in electrical contact with the cathode wherein the lithium-doped nanodiamond particles are positioned on the cathode as a monolayer wherein the cathode is a metal alloy; a cathode on a substrate and lithium-doped nanodiamond particles in electrical contact with the cathode wherein the cathode is a metal alloy containing nickel chromium, indium and lithium components, and a cathode on a substrate and lithium-doped nanodiamond particles in electrical contact with the cathode wherein the layer of lithium-doped nanodiamond particles is coated with a metal having a higher workfunction than the lithium-doped nanodiamond particles.

17. The field-emission device of claim 2, wherein the cathode is a metal alloy.

18. The method of claim 9, wherein the method further comprises thermally treating the field-emission device to adhere the nanodiamond particles to the cathode.
